(19) United States
(12) Patent Application Publication
(10) Pub. No.: US 2023/0410392 A1
(43) Pub. Date: Dec. 21, 2023

(54) CHARACTER INFORMATION APPENDING METHOD, CHARACTER INFORMATION APPENDING APPARATUS AND PROGRAM

(71) Applicant: NIPPON TELEGRAPH AND TELEPHONE CORPORATION, Tokyo (JP)

(72) Inventors: Ai NAKANE, Tokyo (JP); Momoko NAKATANI, Tokyo (JP); Chihiro TAKAYAMA, Tokyo (JP); Yoko ISHII, Tokyo (JP)

(21) Appl. No.: 18/251,466

(22) PCT Filed: Nov. 17, 2020
(86) PCT No.: PCT/JP2020/042780

§ 371 Date: May 2, 2023

(51) Int. Cl. G06T 11/20; G10L 15/18; G06F 3/01

(52) U.S. Cl. CPC G06T 11/203; G10L 15/1815; G06F 3/013

(57) ABSTRACT

A computer executes a character information acquisition procedure of acquiring, for each utterance in a dialogue, character information indicating content of the utterance and information indicating timing at which the utterance is made, a picture area information acquisition procedure of acquiring information indicating an area of a picture drawn during the dialogue and information indicating timing at which the picture is drawn, and an association procedure of specifying the character information to be associated with the area, based on the timing at which the picture is drawn and the timing at which the utterance is made, thereby reducing a burden of assigning character information to drawing content.

### TECHNICAL FIELD

The present invention relates to a character information appending method, a character information appending apparatus, and a program.

### BACKGROUND ART

Conventionally, there is a method of assigning character information to a still image and a moving image (for example, Patent Literature 1). The method is a method of preparing a reference image to which characters representing features of an image are assigned in advance, calculating a relevance degree between a certain image and the reference image, and assigning character information assigned to the reference image having a relevance degree equal to or greater than a threshold value to the certain image.

### CITATION LIST

### Patent Literature

Patent Literature 1: JP 2014-74943 A

### SUMMARY OF INVENTION

### Technical Problem

However, in an example of graphic recording or the like that expresses drawing information related to content of a dialogue performed by a plurality of persons, a simple illustration is often symbolically used, and it is difficult to assign character information from the relevance degree with the reference image. In the conventional method, content of the dialogue performed in relation to the drawn picture cannot be used for assigning the character information, and the relevance degree between the assigned character information and the drawn picture becomes low.

The present invention was made in view of the above points, and an object thereof is to reduce a burden of assigning (appending) character information to drawing content.

### Solution to Problem

Here, in order to solve the above problems, a computer executes a character information acquisition procedure of acquiring, for each utterance in a dialogue, character information indicating content of the utterance and information indicating timing at which the utterance is made, a picture area information acquisition procedure of acquiring information indicating an area of a picture drawn during the dialogue and information indicating timing at which the picture is drawn, and an association procedure of specifying the character information to be associated with the area, based on the timing at which the picture is drawn and the timing at which the utterance is made.

### Advantageous Effects of Invention

It is possible to reduce a burden of assigning (appending) character information to drawing content.

### BRIEF DESCRIPTION OF DRAWINGS

FIG. 1 is a diagram illustrating a hardware configuration example of a character information assigning device 10 according to a first embodiment.

FIG. 2 is a diagram illustrating a functional configuration example of the character information assigning device 10 according to the first embodiment.

FIG. 3 is a flowchart for explaining an example of a processing procedure executed by the character information assigning device 10 according to the first embodiment.

FIG. 4 is a diagram illustrating a configuration example of a character information DB.

FIG. 5 is a diagram illustrating a configuration example of a picture area information DB.

FIG. 6 is a diagram for explaining a picture area.

FIG. 7 is a diagram illustrating a configuration example of an area character information correspondence DB according to the first embodiment.

FIG. 8 is a diagram illustrating a functional configuration example of the character information assigning device 10 according to a second embodiment.

FIG. 9 is a flowchart for explaining an example of a processing procedure executed by the character information assigning device 10 according to the second embodiment.

FIG. 10 is a diagram illustrating a configuration example of a line-of-sight area information DB.

FIG. 11 is a diagram for explaining a line-of-sight area.

FIG. 12 is a diagram illustrating a configuration example of the area character information correspondence DB according to the second embodiment.

FIG. 13 is a diagram illustrating a functional configuration example of the character information assigning device 10 according to a third embodiment.

FIG. 14 is a flowchart for explaining an example of a processing procedure of weighting processing according to the third embodiment.

FIG. 15 is a diagram illustrating a configuration example of a weighting information DB.

### DESCRIPTION OF EMBODIMENTS

Hereinafter, embodiments of the present invention will be described with reference to the drawings. In a first embodiment, an example will be described in which, when a picture, an illustration, a drawing, or the like (hereinafter, referred to as a “picture”) associated with a dialogue is drawn at any time during a dialogue in graphic recording or the like, character information is assigned (appended) to the picture by using the time (timing) at which the picture is drawn and the time (timing) of the dialogue.

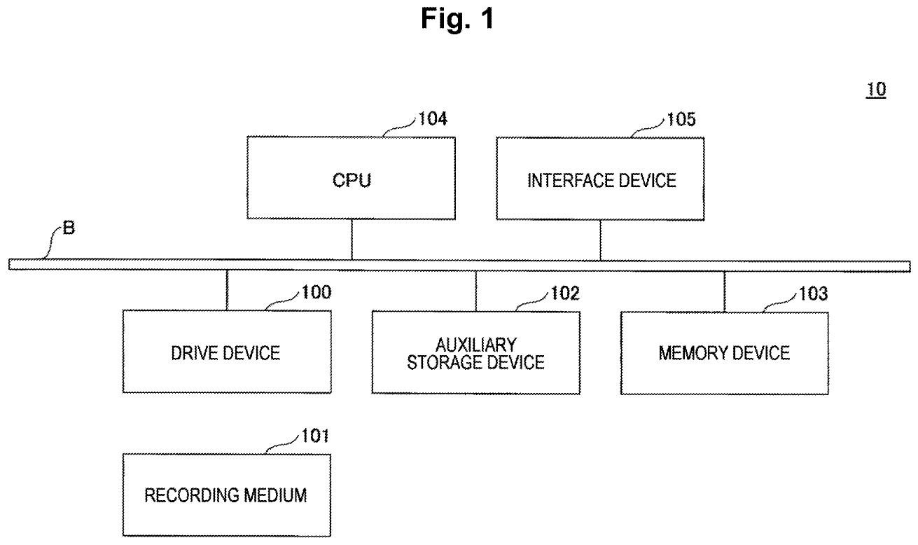

FIG. 1 is a diagram illustrating a hardware configuration example of a character information assigning device 10 (character information appending apparatus) according to the first embodiment. The character information assigning device 10 in FIG. 1 includes a drive device 100, an auxiliary storage device 102, a memory device 103, a CPU 104, an interface device 105, and the like which are connected to each other by a bus B.

A program for realizing processing in the character information assigning device 10 is provided by a recording medium 101 such as a CD-ROM. When the recording medium 101 storing a program is set in the drive device 100, the program is installed on the auxiliary storage device 102 from the recording medium 101 via the drive device 100. However, the program is not necessarily installed from the recording medium 101 and may be downloaded from another computer via a network. The auxiliary storage device 102 stores the installed program and also stores necessary files, data, and the like.

When an instruction to start the program is issued, the memory device 103 reads the program from the auxiliary storage device 102 and stores the program. The CPU 104 executes a function related to the character information assigning device 10 according to the program stored in the memory device 103. The interface device 105 is used as an interface for connecting to a network.

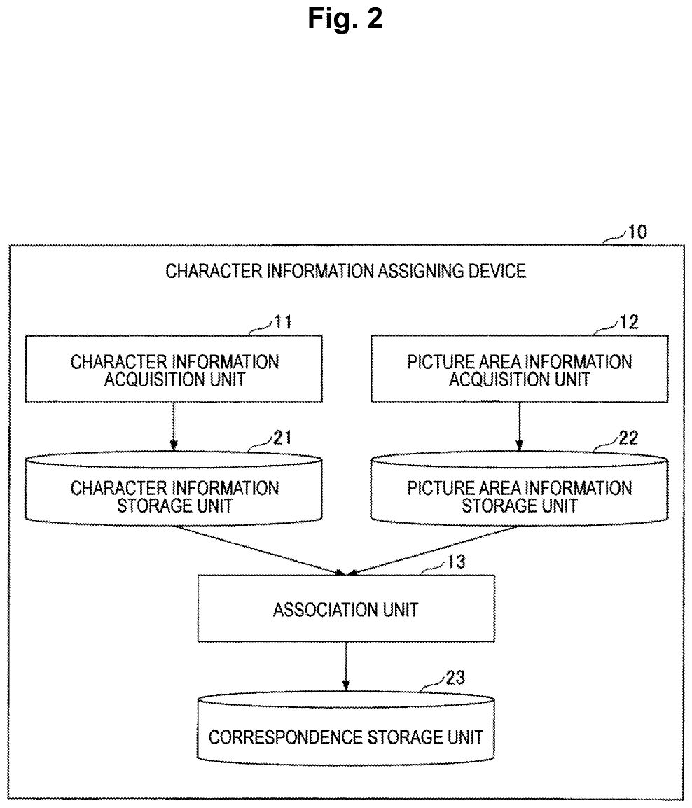

FIG. 2 is a diagram illustrating a functional configuration example of the character information assigning device 10 according to the first embodiment. In FIG. 2, the character information assigning device 10 includes a character information acquisition unit 11, a picture area information acquisition unit 12, and an association unit 13. These units are realized by processing executed by the CPU 104 by one or more programs installed on the character information assigning device 10. The character information assigning device 10 also uses a character information storage unit 21, a picture area information storage unit 22, and a correspondence storage unit 23. Each of these storage units can be realized by using, for example, the auxiliary storage device 102 or a storage device connectable to the character information assigning device 10 via a network.

The character information acquisition unit 11 inputs voice in the dialogue, acquires character information (information indicating the timing of the utterance and character information indicating the content of the utterance) from the voice, and records the acquired information in the character information storage unit 21 as a character information DB.

The picture area information acquisition unit 12 inputs a photographed image of an area (a paper surface, a whiteboard, a screen that is a digital drawing destination, or the like) where drawing is scheduled to be performed during the dialogue or a digitally drawn image at any time, acquires, from the photographed video, information indicating timing at which the drawing of the picture is performed and information indicating an area of the drawn picture, and records the acquired information in the picture area information storage unit 22 as a picture area information DB.

The association unit 13 generates an area character information correspondence DB by specifying character information to be associated with the area where drawing was performed, based on the information indicating the timing at which the utterance was performed and the information indicating the timing at which the drawing was performed, and records the area character information correspondence DB in the correspondence storage unit 23.

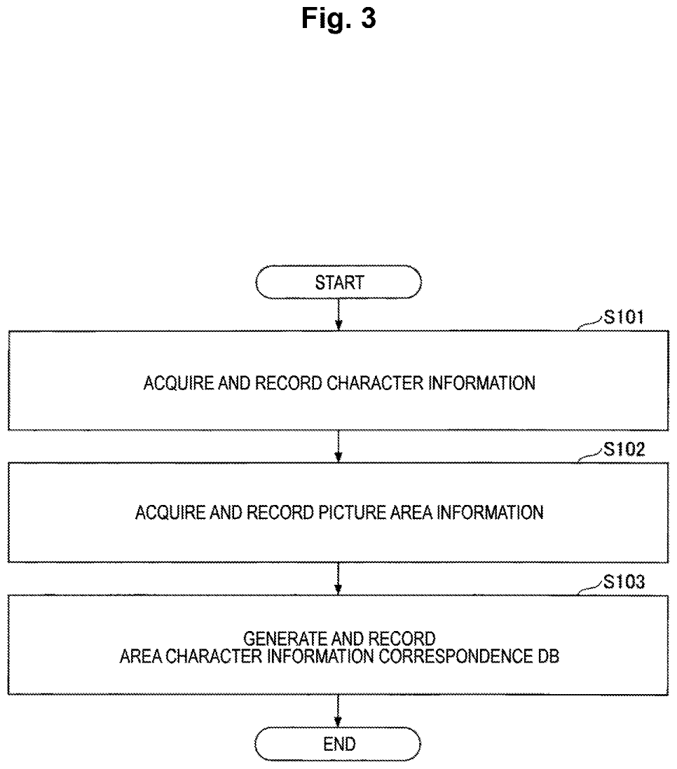

FIG. 3 is a flowchart for explaining an example of a processing procedure executed by the character information assigning device 10 according to the first embodiment.

In the period during which the dialogue is performed, the character information acquisition unit 11 acquires character information from the input voice, and records the acquired information in the character information storage unit 21 as the character information DB (S101).

Specifically, the character information acquisition unit 11 specifies a time frame (timing) in which each utterance is made based on a voice input from a microphone installed in a place where the dialogue occurs.

Furthermore, the character information acquisition unit 11 extracts words uttered within each time frame as character information from the result of the morphological analysis of the utterance content included in the voice, generates a character information DB, and records the character information DB in the character information storage unit 21. However, morphological analysis is not necessarily used to extract words.

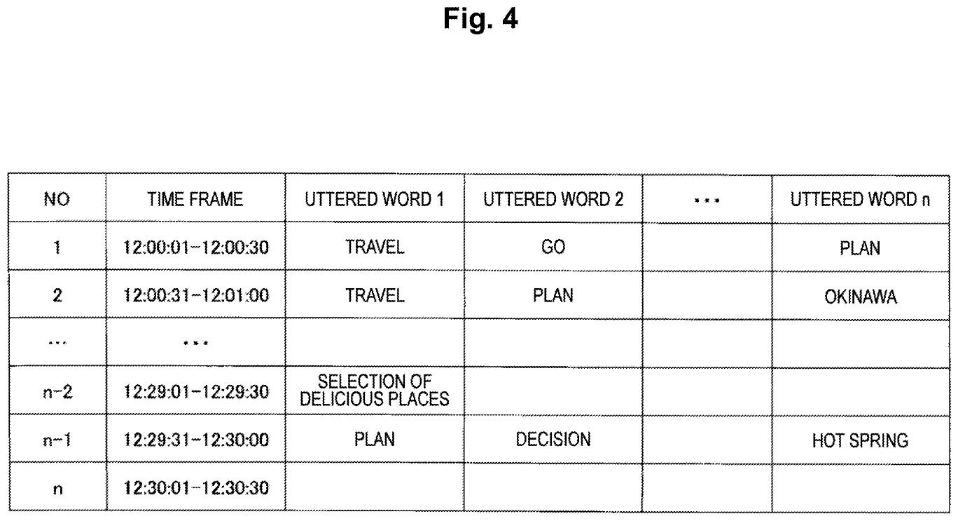

FIG. 4 is a diagram illustrating a configuration example of the character information DB. As illustrated in FIG. 4, the character information DB is a database in which words included in an utterance performed in a time frame (time section) are recorded as character information for each time frame. In the example of FIG. 4, the length of the time frame is 30 seconds, but it is not limited thereto. Furthermore, each time frame may be specified not by time but by information such as relative time with which a temporal relationship between character information and picture area information can be understood. For example, the character information acquisition unit 11 and the picture area information acquisition unit 12 may input time information from the same timer.

Furthermore, in order to extract a characteristic word, not all the uttered words but only words uttered x or more times may be extracted. Further, for each word, the deviation of the appearance frequency of the word in all the time frames may be calculated (for example, a standard deviation or the like of the number of appearances in each time frame), and only a word having a large deviation (for example, the standard deviation is 2.0 or more) may be extracted.

In addition, in the period during which the dialogue is being performed, the picture area information acquisition unit 12 acquires the picture area information from the input image (for example, an image obtained by photographing, with a camera, a paper surface, a whiteboard, or the like on which a picture is drawn in a dialogue) and acquires information indicating the timing at which drawing is performed, and records the acquired information as the picture area information DB in the picture area information storage unit 22 (S102). That is, steps S101 and S102 are executed in parallel.

Specifically, the picture area information acquisition unit 12 extracts an area of a picture drawn in a time frame, and generates the picture area information DB based on an extraction result, for each time frame. The picture area information may be, for example, information indicating a minimum circumscribed rectangle of the drawn picture.

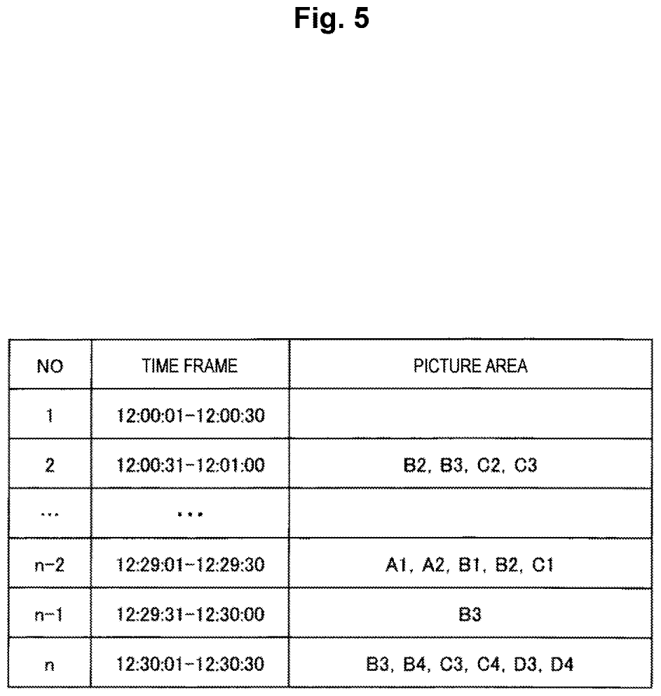

FIG. 5 is a diagram illustrating a configuration example of the picture area information DB. As illustrated in FIG. 5, the picture area information DB is a database in which an area (picture area) of a picture drawn in a time frame is recorded for each time frame (time section). Note that the definition of the time frame may be similar to that of the character information DB. One picture area may be an area of a set of lines drawn in a time frame instead of an area of one picture (a picture or the like with a particular meaning).

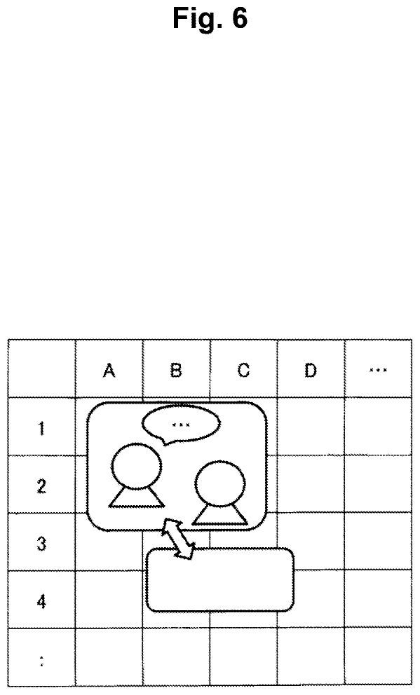

In FIG. 5, the picture area is represented by a set of symbols such as “B2” and “B3”, but these are identifiers of minimum units constituting the picture area, and the identifiers are based on the coordinate system illustrated in FIG. 6.

FIG. 6 is a diagram for explaining the picture area. FIG. 6 illustrates an example in which an area (paper surface, whiteboard, or the like) where drawing is scheduled to be performed is divided by a rectangle (or a square). Each rectangle corresponds to the minimum unit of the picture area. The position of each rectangle is identified by an alphabet in the horizontal direction and by a number in the vertical direction. This combination of an alphabet and a number is an identifier of a minimum unit of the picture area. Hereinafter, the minimum unit is referred to as a “cell”.

At any timing in the middle of the dialogue (for example, periodic timing) or at any timing after the end of the dialogue, or in response to a predetermined input by the user, the association unit 13 generates the area character information correspondence DB by specifying the character information associated with the picture area based on the timing at which the picture is drawn and the timing at which the utterance is made, and records the area character information correspondence DB in the correspondence storage unit 23 (S103).

Specifically, the association unit 13 associates the character information (uttered word) with the picture area information based on the time information (time frame) of each of the character information DB and the picture area information DB. For example, the association unit 13 associates a picture area corresponding to a time frame obtained by adding 30 seconds to the time frame, with an uttered word in a certain time frame. The association unit 13 records a result of association between the uttered word and the picture area information in the correspondence storage unit 23 as the area character information correspondence DB.

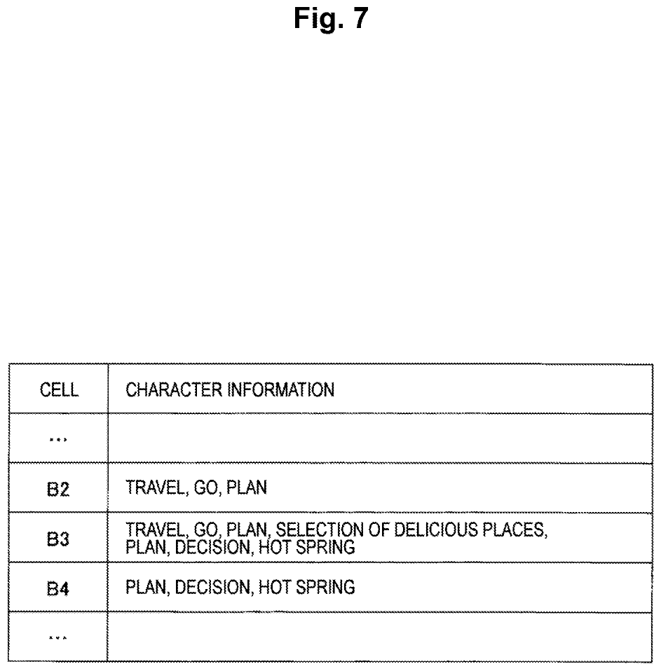

FIG. 7 is a diagram illustrating a configuration example of the area character information correspondence DB according to the first embodiment. As illustrated in FIG. 7, the area character information correspondence DB is a database in which character information (uttered word) associated with a figure (a picture including the cell in the picture area) drawn for a cell is recorded for each cell constituting any picture area. FIG. 7 illustrates an example in which a picture area corresponding to a time frame after 30 seconds is associated with an uttered word at a certain time as described above. Specifically, according to FIG. 5, in the cell B2, drawing is performed in a time frame of 12:00:31 to 12:01:00. On the other hand, FIG. 4 illustrates that words such as “travel”, “go”, and “plan” are uttered in a time frame (12:00:01 to 12:00:30) 30 seconds before the above. Therefore, the cell B2 and these words are associated with each other. Further, according to FIG. 5, in the cell B3, drawing is performed in three time frames of 12:00:31 to 12:01:00, 12:29:31 to 12:30:00, and 12:30:01 to 12:30:30. On the other hand, FIG. 4 illustrates that words such as “travel, go, plan”, “take a delicious place”, and “plan, decision, hot spring” are uttered in a time frame (12:00:01 to 12:00:30, 12:29:01 to 12:29:30, and 12:29:31 to 12:30:00) 30 seconds before each time frame. Therefore, the cell B3 and these words are associated with each other.

In this manner, the content of the area character information correspondence DB indicates character information assigned to a picture which is drawing content during a dialogue.

Note that, in the above description, the shift time is set to 30 seconds in the associating the character information with the picture area, but the shift may be set to a time other than 30 seconds. In addition, instead of uniformly shifting the time, the shifting time may be dynamically changed. For example, in a case where characters are included in a picture, character recognition may be performed, and an utterance time frame in which the same word appears and a picture area of the picture may be associated with each other.

As described above, according to the first embodiment, character information is automatically assigned to the drawing content. Therefore, it is possible to reduce a burden of assigning character information to drawing content. That is, it is possible to easily assign the character information to a picture related to the dialogue expressed while performing a dialogue, such as graphic recording, or a picture referred to during the dialogue, and it is possible to reduce the labor of the user to assign appropriate character information. Furthermore, by using the content of the related dialogue for assigning the character information, it is possible to assign the character information having a high relevance degree to the image information.

Next, a second embodiment will be described. In the second embodiment, points different from the first embodiment will be described. Points that are not specifically described in the second embodiment may be similar to those in the first embodiment. In the second embodiment, an example in which character information is assigned to drawing content by using the time of utterance and the time in the line-of-sight direction of the interlocutor will be described.

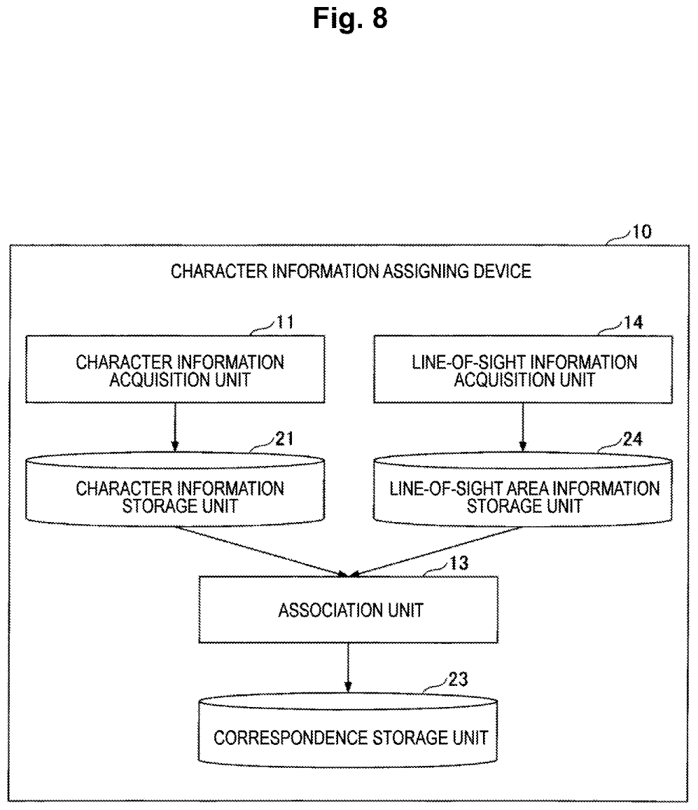

FIG. 8 is a diagram illustrating a functional configuration example of the character information assigning device 10 according to the second embodiment. In FIG. 8, the same or corresponding parts as those in FIG. 2 are denoted by the same reference numerals, and the description thereof will be omitted as appropriate.

In FIG. 8, the character information assigning device 10 includes a line-of-sight information acquisition unit 14 instead of the picture area information acquisition unit 12. The line-of-sight information acquisition unit 14 is realized by processing executed in the CPU 104 by one or more programs installed on the character information assigning device 10. The character information assigning device 10 also uses a line-of-sight area information storage unit 24 instead of the picture area information storage unit 22. The line-of-sight area information storage unit 24 can be realized by using, for example, the auxiliary storage device 102 or a storage device connectable to the character information assigning device 10 via a network.

The line-of-sight information acquisition unit 14 acquires, in a certain time frame, an area to which the line of sight of the participant of the dialogue was directed and timing at which the line of sight is directed to the area, out of an area in which drawing is performed (paper surface, whiteboard, or the like), and records information indicating the timing and information indicating the area to which the line of sight was directed (hereinafter, referred to as a “line-of-sight area”) in the line-of-sight area information storage unit 24 as the line-of-sight area information DB. Note that the line of sight may be a line of sight of one specific participant (for example, a participant who is drawing) among the participants of the dialogue, or may be lines of sight of a plurality of participants. In either case, the line-of-sight area of the participant may be specified by, for example, analyzing an image (video) obtained by photographing the dialogue, or may be specified by using a wearable device worn by the participant.

The association unit 13 generates the area character information correspondence DB by specifying character information associated with the line-of-sight area based on the timing at which the line of sight is directed to the area and the timing at which the utterance is made, and records the area character information correspondence DB in the correspondence storage unit 23. In the second embodiment, the line-of-sight area is estimated as a picture area. This is because, when drawing is being performed, there is a high possibility that the line of sight of the participant is focused on the drawn figure.

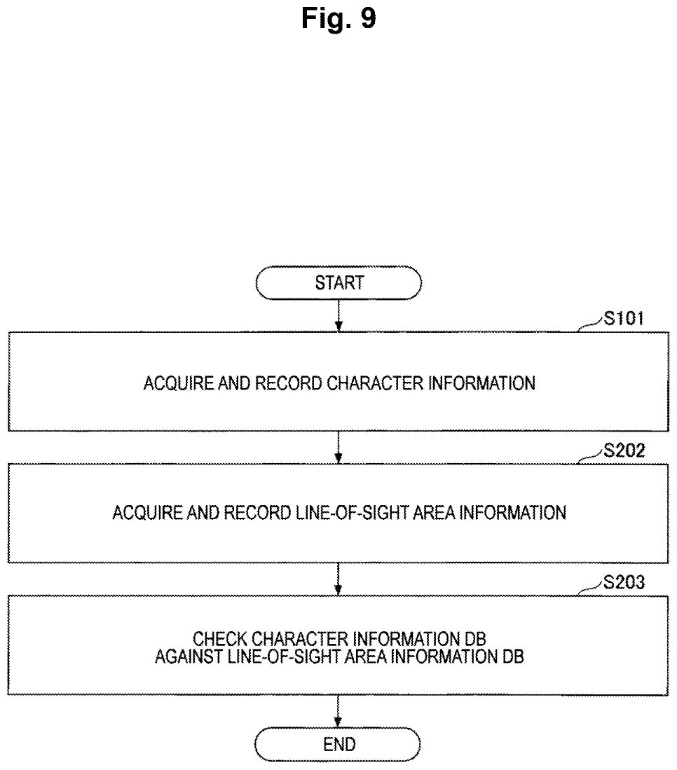

FIG. 9 is a flowchart for explaining an example of a processing procedure executed by the character information assigning device 10 according to the second embodiment. In FIG. 9, the same steps as those in FIG. 3 are denoted by the same step numbers, and the description thereof will be omitted.

In the period during which the dialogue is performed, the line-of-sight information acquisition unit 14 acquires information indicating an area where the line of sight of the participant of the dialogue stays for 10 seconds or more in total within a time frame, and records the information indicating the area in the line-of-sight area information storage unit 24 as the line-of-sight area information DB, for each time frame (S202). That is, step S201 is executed in parallel with step S101.

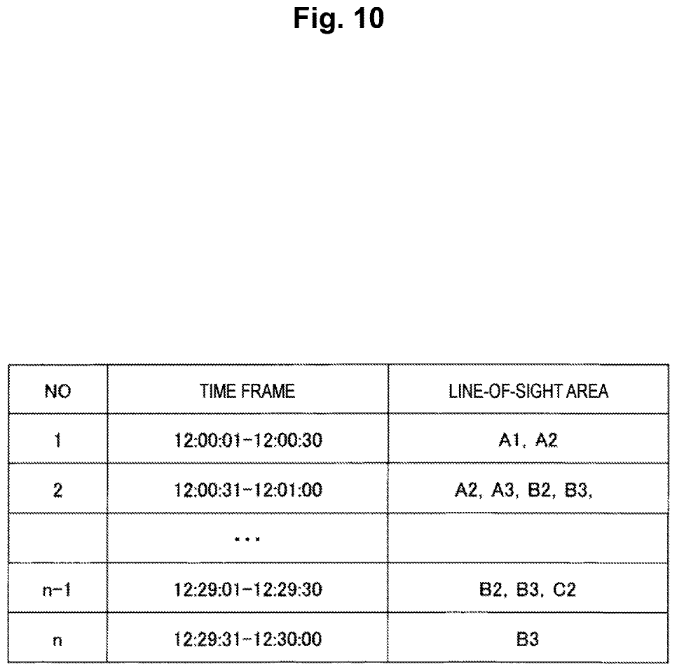

FIG. 10 is a diagram illustrating a configuration example of the line-of-sight area information DB. As illustrated in FIG. 10, the line-of-sight area information DB is a database in which an identifier of a cell, to which a line of sight of a participant of the dialogue is directed (staying for 10 seconds or more in total) in a time frame, is recorded for each time frame. The definition of the time frame may be similar to that of the character information DB. In the above description, the line of sight stays for 10 seconds or more in total, but may stay for any number of seconds less than 10 seconds. In addition, instead of the number of seconds, an area (cell) having the highest rate of the stay time of the line of sight in the time frame may be used. In addition, the condition that the line-of-sight area (the area to which the line of sight is directed) is an area where the lines of sight of p or more participants among the dialogue participants are gathered in the same area may be used.

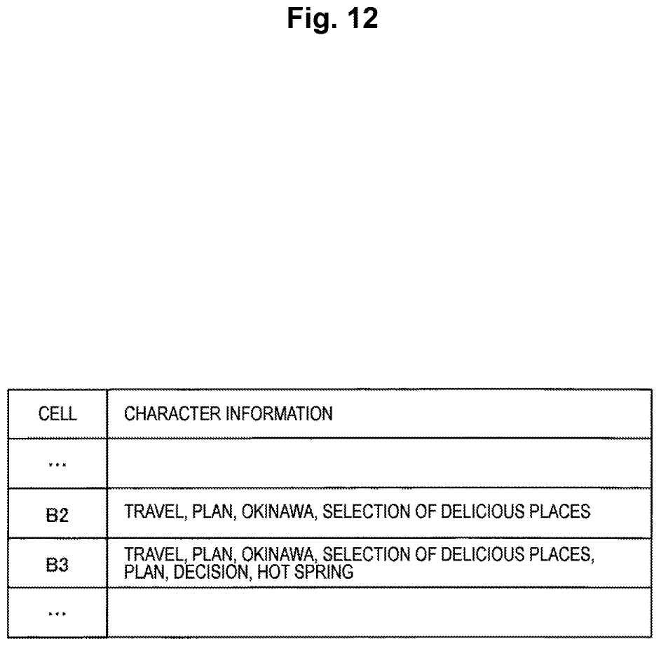

In FIG. 10, the line-of-sight area is represented by a set of symbols such as “A1” and “A2”, but these are identifiers of minimum units (cells) of the picture area, and the identifiers are based on the coordinate system illustrated in FIG. 12.

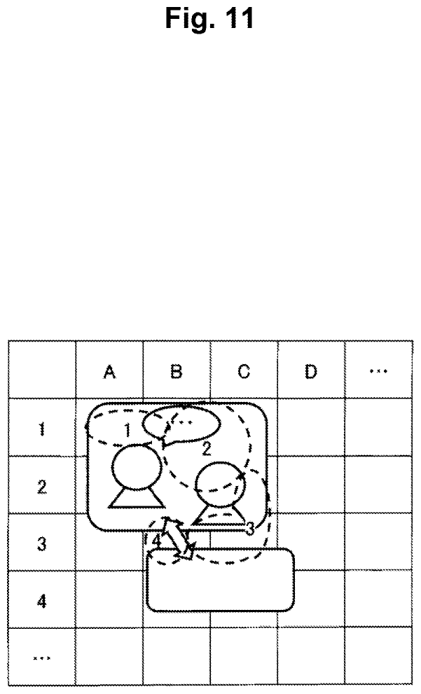

FIG. 11 is a diagram for explaining the line-of-sight area. In FIG. 11, a broken-line ellipse indicates the line-of-sight area. Note that the coordinate system of FIG. 11 is the same as the coordinate system of FIG. 6.

At any timing in the middle of the dialogue (for example, periodic timing) or at any timing after the end of the dialogue, or in response to a predetermined input by the user, the association unit 13 generates the area character information correspondence DB by checking the character information DB against the line-of-sight area information DB and associating the character information with the line-of-sight area information based on the time information of each DB, and records the area character information correspondence DB in the correspondence storage unit 23 (S203).

Specifically, the association unit 13 associates an uttered word extracted in a certain time frame with a line-of-sight area in a certain time frame based on character information of the certain time frame and line-of-sight area information indicating an area to which the line of sight was directed in the time frame.

FIG. 12 is a diagram illustrating a configuration example of the area character information correspondence DB according to the second embodiment. The configuration of the area character information correspondence DB according to the second embodiment is similar to that in the first embodiment. However, as described above, each picture area is estimated based on the line-of-sight area. Therefore, the area character information correspondence DB of the second embodiment is a database in which an uttered word corresponding to a picture that would have been drawn for a cell is recorded for each cell constituting the line-of-sight area.

According to FIG. 10, the cell B is included in the line-of-sight area (to which the line of sight is directed) in each time frame of 12:00:31 to 12:01:00 and 12:29:01 to 12:29:30. On the other hand, FIG. 4 illustrates that words such as “travel, plan, Okinawa” and “take a delicious place” are uttered in these time frames. Therefore, in FIG. 12, the cell B2 and these words are associated with each other.

In this manner, the content of the area character information correspondence DB indicates character information assigned to a picture which is drawing content during a dialogue.

As described above, the same effects as those of the first embodiment can also be obtained by the second embodiment.

Next, a third embodiment will be described. In the third embodiment, points different from the second embodiment will be described. Points that are not specifically described in the third embodiment may be similar to those in the second embodiment.

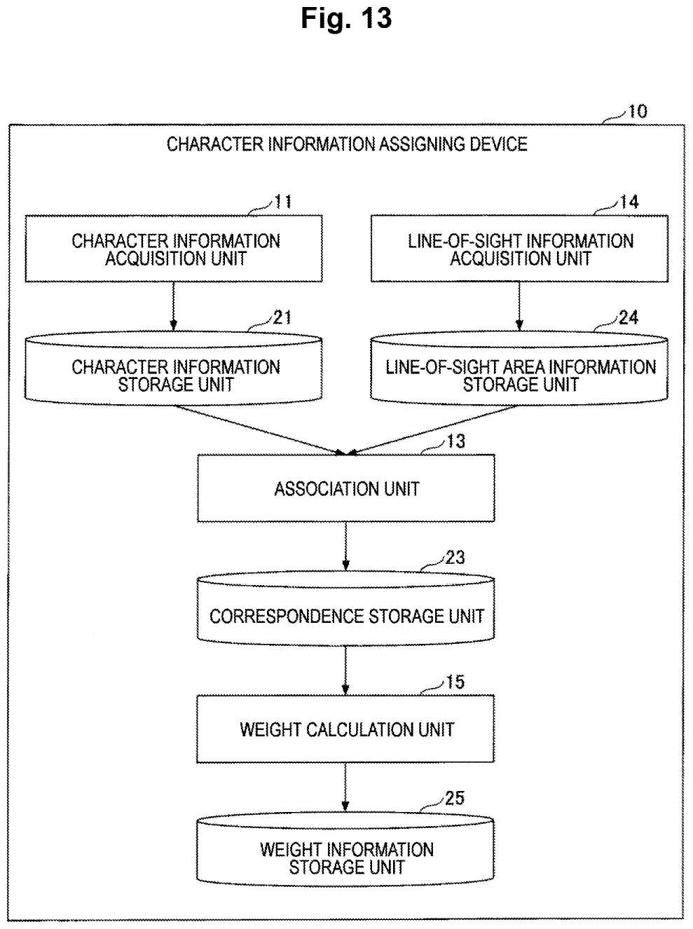

FIG. 13 is a diagram illustrating a functional configuration example of the character information assigning device 10 according to the third embodiment. In FIG. 13, the same parts as those in FIG. 8 are denoted by the same reference numerals, and the description thereof will be omitted.

In the third embodiment, an example in which weighting is performed on the character information (each word) recorded in association with each cell (each partial area constituting the picture area) in the area character information correspondence DB will be described.

In FIG. 13, the character information assigning device 10 further includes a weight calculation unit 15. The weight calculation unit 15 is realized by processing executed by the CPU 104 by one or more programs installed on the character information assigning device 10. The character information assigning device 10 also uses a weight information storage unit 25. The weight information storage unit 25 can be realized by using, for example, the auxiliary storage device 102 or a storage device connectable to the character information assigning device 10 via a network.

The weight calculation unit 15 weights each word stored in the area character information correspondence DB based on the appearance frequency (the number of appearances) of each cell. The result of weighting by the weight calculation unit 15 is recorded in the weight information storage unit 25.

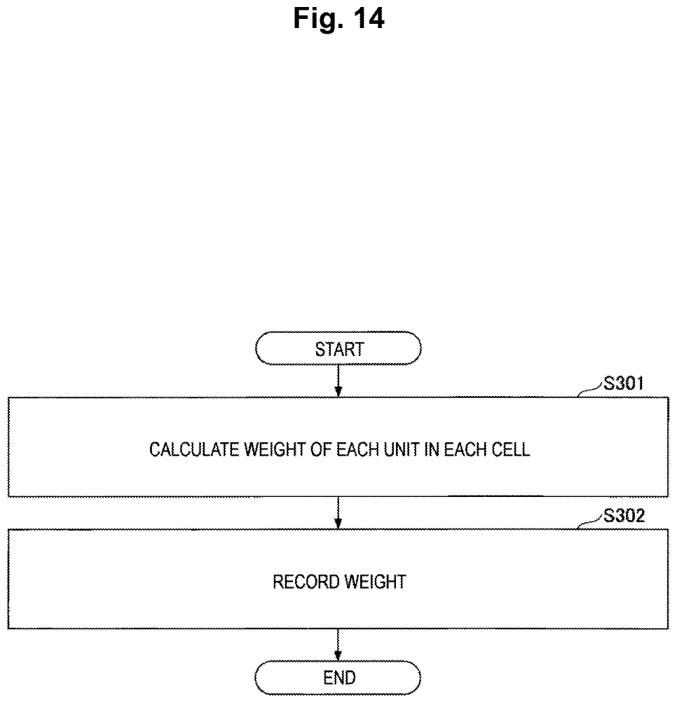

FIG. 14 is a flowchart for explaining an example of a processing procedure of weighting processing according to the third embodiment. For example, FIG. 14 may be executed at any timing after the end of the dialogue.

In step S301, the weight calculation unit 15 refers to the area character information correspondence DB (FIG. 12), and calculates the appearance frequency (the number of appearances) of each word associated with a cell, for each cell registered in the area character information correspondence DB. Here, the appearance frequency of each word is, for example, an appearance frequency in a set of words associated with the same cell. For example, according to FIG. 6, in the set of words associated to the cell B3, the appearance frequency of “Okinawa” is once, and the appearance frequency of “plan” is twice. Therefore, for the cell B3, the weighting coefficient of “Okinawa” is 1, and the weighting coefficient of “plan” is 2.

Subsequently, the weight calculation unit 15 records the weighting result as the weighting information DB in the weight information storage unit 25 (S302).

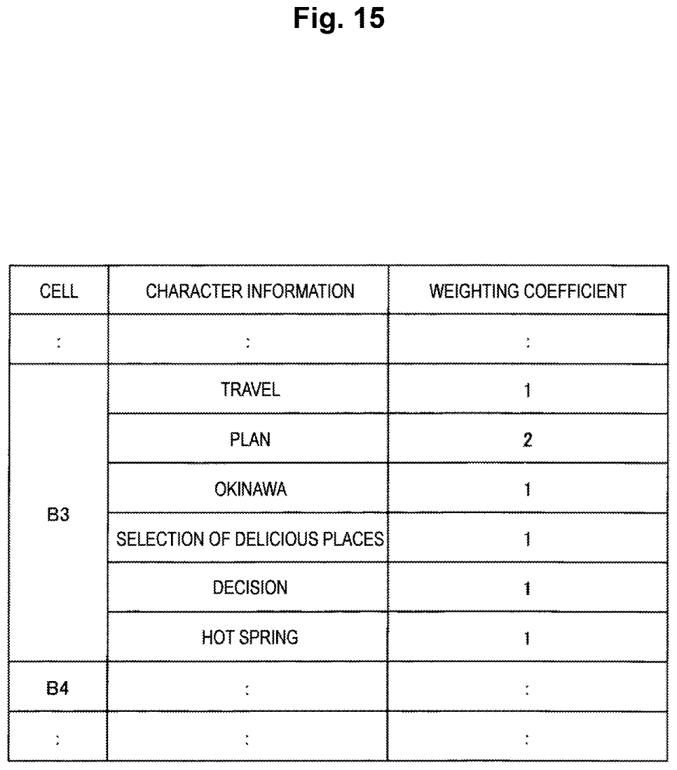

FIG. 15 is a diagram illustrating a configuration example of the weighting information DB. As illustrated in FIG. 15, the weighting information DB is a database in which a weighting coefficient of each word associated with a cell is recorded for each cell.

Note that the weight calculation unit 15 may calculate, for a certain cell, the deviation (for example, a standard deviation or the like of the appearance frequency in each time frame) in the appearance frequency in time series in another cell, and calculate a value corresponding to the magnitude of the deviation as a weighting coefficient. In this case, the larger the deviation, the larger the weighting coefficient.

Note that the weight calculation unit 15 and the weight information storage unit 25 may be combined with the first embodiment.

As described above, according to the third embodiment, the word associated with each cell (partial area constituting the picture area) can be weighted. As a result, relative importance can be assigned to each word corresponding to a figure or the like corresponding to each cell.

Although the embodiments of the present invention have been described in detail above, the present invention is not limited to such specific embodiments, and various modifications and changes can be made within the scope of the gist of the present invention described in the claims.

### REFERENCE SIGNS LIST

10 Character information assigning device
11 Character information acquisition unit
12 Picture area information acquisition unit
13 Association unit
14 Line-of-sight information acquisition unit
15 Weight calculation unit
21 Character information storage unit
22 Picture area information storage unit
23 Correspondence storage unit
24 Line-of-sight area information storage unit
25 Weight information storage unit
100 Drive device
101 Recording medium
102 Auxiliary storage device
103 Memory device
104 CPU
105 Interface device
B Bus

1. A character information appending method executed by a computer, the character information appending method comprising:
acquiring, for each utterance in a dialogue, character information indicating content of the utterance and information indicating timing at which the utterance is made,
acquiring information indicating an area of a picture drawn during the dialogue and information indicating timing at which the picture is drawn, and
specifying the character information to be associated with the area, based on the timing at which the picture is drawn and the timing at which the utterance is made.

2. The character information appending method according to claim 1, wherein
the specifying includes associating, with the area, the character information related to the utterance made at timing before the timing at which the picture is drawn.

3. A character information appending method executed by a computer, the character information appending method comprising:
acquiring, for each utterance in a dialogue, character information indicating content of the utterance and information indicating timing at which the utterance is made,
acquiring information indicating an area to which a line of sight of a participant of the dialogue is directed, out of the area where the picture is drawn during the dialogue, and information indicating timing at which the line of sight is directed to the area, and
specifying the character information to be associated with the area to which the line of sight is directed to the area, based on the timing at which the line of sight is directed to the area and the timing at which the utterance is made.

4. The character information appending method according to claim 1, wherein further comprising:
calculating, by a calculator, a weight for each of a plurality of pieces of character information associated with the area, based on an appearance frequency in the dialogue of the character information is provided.

5. A character information appending apparatus, comprising:
a processor; and
a memory that includes instructions, which when executed, cause the processor to execute:
acquiring, for each utterance in a dialogue, character information indicating content of the utterance and information indicating timing at which the utterance is made,
acquiring information indicating an area of a picture drawn during the dialogue and information indicating timing at which the picture is drawn, and
specifying the character information to be associated with the area, based on the timing at which the picture is drawn and the timing at which the utterance is made.

6. (canceled)

7. A non-transitory computer-readable recording medium storing a program that causes a computer to execute the character information appending method according to claim 1.
